(19) United States
(12) Patent Application Publication
(10) Pub. No.: US 2026/0043748 A1
(43) Pub. Date: Feb. 12, 2026

(54) THERMOMECHANICAL HEATING RESPONSE TESTING SYSTEM

(71) Applicant: National Technology & Engineering Solutions of Sandia, LLC, Albuquerque, NM (US)

(72) Inventors: Wyatt Lea Hodges, Albuquerque, NM (US); Amun Jarzembski, Albuquerque, NM (US); Aleem Mohammad Siddiqui, Albuquerque, NM (US); Gregory William Pickrell, Rio Rancho, NM (US)

(21) Appl. No.: 19/201,542

(22) Filed: May 7, 2025

Related U.S. Application Data
(60) Provisional application No. 63/680,114, filed on Aug. 7, 2024.

(51) Int. Cl. G01N 21/95; G01N 21/45

(52) U.S. Cl. CPC G01N 21/95; G01N 21/45; G01N 2201/06113; G01N 2201/0633; G01N 2201/0636

(57) ABSTRACT

A thermomechanical heating response testing system and methods of performing a thermomechanical test on a sample are presented. A thermomechanical heating response testing system comprises a dichroic mirror configured to combine beams from a plurality of lasers, an objective immediately following the dichroic mirror, the plurality of lasers, and a multichannel lock-in amplifier configured to receive input from a thermal probe detector configured to receive a thermal probe sample beam of the thermal probe laser reflected from a sample and a mechanical probe detector configured to receive a mechanical probe sample beam of the mechanical probe laser reflected from the sample. The objective is configured to focus the beams of the plurality of lasers in a coaxial configuration on a sample. The plurality of lasers comprises a heating laser having a first wavelength, a thermal probe laser having a second wavelength, and a mechanical probe laser having a third wavelength.

### STATEMENT OF GOVERNMENT INTEREST

This invention was made with United States Government support under Contract No. DE-NA0003525 between National Technology & Engineering Solutions of Sandia, LLC and the United States Department of Energy. The United States Government has certain rights in this invention.

### BACKGROUND

### 1. Field

The disclosure relates generally to testing material properties, and more specifically to simultaneously testing a temperature response and mechanical displacement.

### 2. Description of the Related Art

Heterogeneously integrated (HI) microelectronic systems are common in consumer electronics, where functionality demands are relatively low and reliability has low consequences. Accordingly, use in consumer electronics does not require complete understanding of failure modes or of individual reliability of HI electronic systems.

The increased functionality and decreased footprint offered by HI electronic system technology are desirable in commercial or governmental systems. However, because of the high consequences of a failed system, extreme reliability is needed from any component, including reliability in extreme environments that consumer electronics are not exposed to. Accordingly, it is desirable to build systems with sufficient reliability for governmental use. It is also desirable to have an understanding of failure mechanisms of HI electronics and methods to identify inconsistencies in HI electronic systems.

Metal bump bond interconnects that connect components of the HI architecture are often the site of thermomechanical failure in HI microsystems. Improved ability to evaluate state of health of interconnects will lead to better understanding of device failure. Current methods of testing HI electronic systems include electrical testing, visual screening, and C-SAM. However, current techniques either cannot sense partial debonds or are unable to see subsurface features.

Therefore, it would be desirable to have a method and apparatus that take into account at least some of the issues discussed above, as well as other possible issues.

### SUMMARY

An illustrative embodiment provides a thermomechanical heating response testing system. The thermomechanical heating response testing system comprises a dichroic mirror configured to combine beams from a plurality of lasers, an objective immediately following the dichroic mirror, the plurality of lasers, and a multichannel lock-in amplifier configured to receive input from a thermal probe detector configured to receive a thermal probe sample beam of the thermal probe laser reflected from a sample and a mechanical probe detector configured to receive a mechanical probe sample beam of the mechanical probe laser reflected from the sample. The objective is configured to focus the beams of the plurality of lasers in a coaxial configuration on a sample. The plurality of lasers comprises a heating laser having a first wavelength, a thermal probe laser having a second wavelength, and a mechanical probe laser having a third wavelength.

Another illustrative embodiment provides a method of performing a thermomechanical test on a sample. Beams from a heating laser, a thermal probe laser, and a mechanical probe laser are combined using a dichroic mirror. Combined beams of the heating laser, the thermal probe laser, and the mechanical probe laser are focused from the dichroic mirror to a portion of a sample using a single objective. Reflected signals of the thermal probe laser and reflected signals of the mechanical probe laser from the sample are spectrally separated using the dichroic mirror. The heating laser is blocked from progressing in the sample path of the thermal probe laser by a second dichroic mirror. The separated reflected signals of the thermal probe laser are received after the second dichroic mirror at a thermal probe detector. Separated reflected signals of the mechanical probe laser are received at a mechanical probe detector.

Yet another illustrative embodiment provides a method of performing a thermomechanical test on a sample. Beams of a heating laser, a thermal probe laser, and a mechanical probe laser are directed at a portion of a sample using a dichroic mirror and a single objective. Reflected signals of the thermal probe laser and the mechanical probe laser are received from the sample. Data for amplitude and phase of the reflected signals of the thermal probe laser and the mechanical probe laser are simultaneously acquired at a multichannel lock-in amplifier. Mechanical displacement and temperature response are determined from the data.

The features and functions can be achieved independently in various examples of the present disclosure or may be combined in yet other examples in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is an illustration of a block diagram of a testing environment in accordance with an illustrative embodiment;

FIG. 2 is an illustration of a basic layout of a thermomechanical heating response testing system in accordance with an illustrative embodiment;

FIG. 3 is an illustration of a detailed layout of a thermomechanical heating response testing system in accordance with an illustrative embodiment;

FIGS. 4A and 4B is a flowchart for performing a thermomechanical test on a sample in accordance with an illustrative embodiment; and

FIG. 5 is a flowchart for performing a thermomechanical test on a sample in accordance with an illustrative embodiment.

### DETAILED DESCRIPTION

The illustrative embodiments recognize and take into account one or more different considerations. For example, the illustrative embodiments recognize and take into account that it is desirable to present a testing system that can sense partial debonds.

The illustrative examples provide an optical setup to non-destructively perform simultaneous thermal and mechanical failure analysis on metal bump bond interconnects between HI devices. The optical system can be referred to as T-MeHR (Thermo-Mechanical Heating Response).

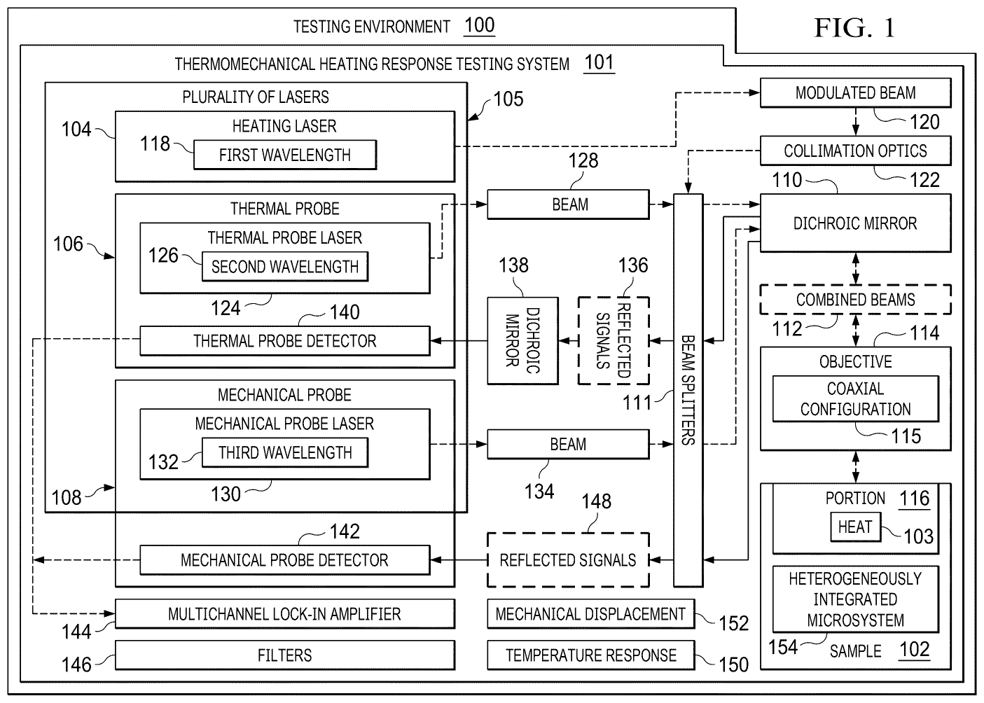

Turning now to FIG. 1, an illustration of a block diagram of a testing environment is depicted in accordance with an illustrative embodiment. Thermomechanical heating response testing system 101 is present in testing environment 100 for performing thermomechanical testing on sample 102. To perform thermal testing on sample 102, heating laser 104 and thermal probe 106 are provided. Thermal probe 106 is simultaneously operated with mechanical probe 108 configured to mechanically test sample 102. In this illustrative example, thermal probe 106 comprises thermal probe laser 124 and mechanical probe 108 comprises mechanical probe laser 130. Thermal probe laser 124 and mechanical probe laser 130 are lasers of plurality of lasers 105. The illustrative examples provide focusing and polarizing optics to direct the three beams of plurality of lasers 105 through the center of objective 114, which focuses the beams on the sample of interest, sample 102. In some illustrative examples, objective 114 comprises a microscope objective.

Thermomechanical heating response testing system 101 comprises dichroic mirror 110 configured to combine beams from plurality of lasers 105, objective 114 immediately following dichroic mirror 110, plurality of lasers 105, and multichannel lock-in amplifier 144. Objective 114 is configured to focus the beams of plurality of lasers 105 in coaxial configuration 115 on sample 102. Plurality of lasers 105 comprises heating laser 104 having first wavelength 118, thermal probe laser 124 having second wavelength 126, and mechanical probe laser 130 having third wavelength 132. Multichannel lock-in amplifier 144 is configured to receive input from a thermal probe detector 140 configured to receive a thermal probe sample beam of the thermal probe laser reflected from a sample and a mechanical probe detector configured to receive a mechanical probe sample beam of the mechanical probe laser reflected from the sample. The mechanical probe sample beam interferes with the mechanical probe reference beam such leading to sample displacement sensitivity.

Dichroic mirror 110 is used to combine the different wavelengths of modulated beam 120, beam 128, and beam 134 prior to sample 102. Reflected signals 136 of the thermal probe laser 124 and reflected signals 148 of mechanical probe laser 130 from sample 102 are spectrally separated using dichroic mirror 110 and separated from the incident beam using beamsplitters 111. Beamsplitters 111 are used to separate out the reflected beams, reflected signals 136 and reflected signals 148, that are directed to thermal probe detector 140 and mechanical probe detector 142.

The wavelengths of plurality of lasers 105 are selected based on intended operation of each laser as well as differences between each wavelength of plurality of lasers 105. The purpose of heating laser 104 is to heat sample 102. First wavelength 118 is configured to generate heat 103 in sample 102. More specifically, first wavelength 118 is selected to generate heat 103 in portion 116 of sample 102 when modulated beam 120 of heating laser 104 is directed at sample 102. Heating laser 104 is modulated so the heating at the surface of sample 102 is periodic. Heating laser 104 causes a temperature rise and thermal expansion in sample 102. In some illustrative examples, first wavelength 118 is in the visible light spectrum. In some illustrative examples, first wavelength 118 can be 488 nm.

The purpose of thermal probe laser 124 is to reflect back to a photodetector, thermal probe detector 140. Reflected signals 136 of thermal probe laser 124 are separated from reflected signals 148 of mechanical probe laser 130 by dichroic mirror 110 and separated from heating laser 104 by dichroic mirror 138. The changes in reflected light, differences between reflected signals 136 and beam 128, will be proportional to the temperature rise at the surface of sample 102. In some illustrative examples, first wavelength 118 and second wavelength 126 are in the visible light spectrum. In some illustrative examples, second wavelength 126 can be in the infrared spectrum. In some illustrative examples, 522 nm laser can be selected for second wavelength 126 for thermal probe laser 124. In some illustrative examples, second wavelength 126 can be selected to be 522 nm due to stability in the Coherent 522 nm lasers. In some illustrative examples, second wavelength 126 can be selected to be 532 nm. The difference in wavelength between 522 nm and 532 nm is not large enough to change the thermoreflectance coefficient or alter the function of optical components significantly. In some illustrative examples, at least one of first wavelength 118 or second wavelength 126 is in the UV light spectrum or infrared spectrum.

The purpose of mechanical probe laser 130 is to reflect back to mechanical probe detector 142. The changes between reflected signals 148 and beam 134 indicate mechanical changes at the surface of sample 102. Mechanical probe laser 130 has third wavelength 132 different from first wavelength 118 and second wavelength 126. Third wavelength 132 is different from both first wavelength 118 and second wavelength 126. In some illustrative examples, first wavelength 118 and second wavelength 126 are shorter wavelengths than third wavelength 132. In some illustrative examples, third wavelength 132 is in the infrared spectrum.

Dichroic mirror 110 keeps visible light out of mechanical probe 108. In some illustrative examples, third wavelength 132 can be greater than 785 nm. Interferometer may be more easily performed at longer wavelengths. FDTR can be performed from the UV spectrum up to 1550 nm. However, in thermomechanical heating response testing system 101, second wavelength 126 can have any desirable wavelength as long as second wavelength 126 is shorter than third wavelength 132.

To perform testing on sample 102, heating laser 104 and thermal probe laser 124 are put through collimation optics 122 to focus the lasers onto a surface of sample 102. As depicted, modulated beam 120 of heating laser 104 goes through collimation optics 122 prior to being sent to dichroic mirror 110. Beam 128 of thermal probe laser 124 and beam 134 of mechanical probe laser 130 are also sent to dichroic mirror 110. Dichroic mirror 110 directs combined beams 112 towards sample 102. Objective 114 focuses combined beams 112 in coaxial configuration 115 onto portion 116 of sample 102.

Reflected signals 136 will reflect from sample 102 through objective 114 and dichroic mirror 110. Second dichroic mirror, dichroic mirror 138, is in the sample path of thermal probe laser 124. Reflected signals 136 encounter dichroic mirror 138. Heating laser 104 is blocked from progressing in the sample path of thermal probe laser 124 by dichroic mirror 138. In some illustrative examples, the sample path of thermal probe laser 124 further comprises a band pass filter configured to remove first wavelength 118 from a reference sample.

Heating laser 104 and thermal probe 106 can be considered a frequency domain thermoreflectance (FDTR) system. Mechanical probe 108 can be considered an interferometer system. The illustrative examples utilize thermal and mechanical characterization techniques in a novel system. The illustrative examples can be used to measure thermal and mechanical response of any desirable type of sample, including HI devices. The illustrative examples utilize frequency domain thermoreflectance (FDTR) and interferometry.

Frequency domain thermoreflectance (FDTR) characterizes thermal properties (thermal conductivity, volumetric heat capacity) using a laser pump-probe approach. In the illustrative examples, the pump laser, heating laser 104, is modulated at a set frequency and heats the surface of sample 102 periodically. In the illustrative examples, the probe beam, beam 128 of thermal probe laser 124, continuously monitors the light reflected from the sample surface which changes as function of temperature, proportional to the material's thermoreflectance coefficient. In some illustrative examples, a metal transducer layer, not depicted, is used to gain more favorable absorption and reflectance properties at the pump and probe frequencies. In some illustrative examples, a transducer can comprise gold or aluminum that is deposited in a conformal layer ˜100 nm thick. The transducer layer does not strongly change the ability to characterize metals or semiconductors, though it does utilize additional sample preparation.

In frequency domain thermoreflectance (FDTR), the amplitude and phase lag (relative to modulated beam 120) of the reflected signal are collected at thermal probe detector 140, and the phase data is compared to an analytical model to fit for the thermal properties of interest. The illustrative embodiments recognize and take into account that multiple frequencies can be used in a single dataset that is used for fitting. The illustrative embodiments recognize and take into account that multiple measurement frequencies are utilized because the depth the periodic heating diffuses into sample 102 is inversely proportional to frequency (i.e. lower frequencies have increased penetration into the sample). Therefore, each frequency has a different region (depth and laterally) of sensitivity in sample 102. In FDTR measurements of semiconductors of metals, depth and lateral sensitivity is on the order of 0.1-100 m. Sensitivity is typically smaller in electrical insulators. In some illustrative examples, FDTR measurements across large areas of the sample can be taken using a scanning stage, enabling characterizations on large scales across a material or system.

Multichannel lock-in amplifier 144 receives data from thermal probe detector 140 and mechanical probe detector 142. Data from thermal probe detector 140 is analyzed to determine temperature response 150 of sample 102. Data from mechanical probe detector 142 is analyzed to determine mechanical displacement 152 of sample 102.

Mechanical probe laser 130 is provided to perform interferometry on the surface of sample 102. By measuring both temperature response 150 and mechanical displacement 152 of the surface of sample 102 in response to heating, increased sensitivity is expected whether regions of the sample are bonded to anything at their backside. The illustrative examples can be applied to the metal interconnects on the backside of devices, where thermomechanical failure typically occurs. In some illustrative examples, sample 102 takes the form of heterogeneously integrated microsystem 154. In some illustrative examples, debonded regions of metal interconnects in heterogeneously integrated microsystem 154 can be identified. By identifying debonded regions of metal interconnects, a new mode of thermomechanical failure analysis is presented that does not utilize cross sectioning the sample. In some illustrative examples, variation in the coefficient of thermal expansion can be identified.

Thermomechanical heating response testing system 101 can be referred to as (T-MeHR). The T-MeHR system measures both surface temperature response 150 and mechanical displacement 152 as surface displacement response to periodic laser heating including imaging thermal and mechanical response of the sample simultaneously.

Heating laser 104 is driven at multiple frequencies at the same time. Thermomechanical heating response testing system 101 detects thermal and mechanical responses simultaneously that needs to be parsed. In some illustrative examples, multichannel lock-in amplifier 144 receives two signals and three separate lock-ins, each at the same time. In these illustrative examples, three different frequencies for the thermal probe detector 140 and the same three frequencies for mechanical probe detector 142 are received at the same time. Multiple frequencies for both detections are utilized. However, having two types of detection halves the amount of frequencies that can be received.

Data processing for the two different signals occurs separately while the measurement occurs simultaneously. The signals are measured from same point at the same time. The data acquisition is done from several different channels from both sides in the lock-in. At a minimum, multichannel lock-in amplifier 144 should have at least 2 lock-ins in the most basic form to accommodate the two inputs.

The illustrative examples map the signals from thermal probe detector 140 and mechanical probe detector 142 simultaneously to generate thermomechanical images. Aligning the focal points of heating laser 104, thermal probe laser 124, and mechanical probe laser 130 allows for spatial mapping of the thermal probe and mechanical probe signals due to heating laser 104 input. Spatial mapping is achieved by raster scanning sample 102, monitoring thermal probe 106 and mechanical probe 108 continuously with multichannel lock-in amplifier 144.

By superposition of multiple pumping frequencies through the TTL driver driving the heating laser 104, maps of thermal probe 106 response and mechanical probe 108 response for multiple pump frequency are all obtained simultaneously.

Line scans produced by thermomechanical heating response testing system 101 have clear delineation between bonded and debonded regions. There can be substantially greater contrast in bonded versus debonded regions in an interferometric amplitude image produced from data collected by mechanical probe detector 142. The free mechanical boundary condition in the debonded region of silicon allows for mechanical vibration, contrasting with the fixed boundary condition for the top layer of silicon in the bonded region. In a thermal image there can be less contrast between amplitude measurements between the bonded and debonded regions. Lateral heat spreading pathways (i.e. parallel to the surface in the top silicon layer) allowing for heat diffusion away from the laser spot contribute to less contrast in the thermal images.

Derivation of thermoreflectance contribution to interferometric signal can be performed as depicted below. Here, we aim to understand the role of surface displacement and thermoreflectance on an interferometric detection scheme. To do so, we need to understand the intensity at a detector (S)

$$S = {\vert E \vert}^{2} = {\vert {E}_{s} + {E}_{r} \vert}^{2} \qquad ( 1 )$$

Where Eₛ and Eᵣ are the interfering electric fields for the signal and reference beams, respectively. Eq. 1 can be expanded out to give

$$S = \vert {E}_{s}^{2} + {E}_{r}^{2} + 2 {E}_{s} {E}_{r} \vert \qquad ( 2 )$$

The fields oscillate at light frequency with a wavelength of 1550 nm. Thus, Eₛ and Eᵣ can be written as

$${E}_{s} = {A}_{s} cos ( {ω}_{L} t + Δϕ ) , \qquad ( 3 )$$

$${E}_{r} = {A}_{r} cos ( {ω}_{L} t ) ,$$

Where ω_{L} is the light frequency, Aₛ and Aᵣ are the signal and reference field amplitudes, respectively, and Δϕ is the optical phase separation between signal and reference beams. Combining Eqs. 2 and 3 yields the well-known interferometry relation:

$$S = \frac{1}{2} {A}_{s}^{2} + \frac{1}{2} {A}_{r}^{2} + {A}_{s} {A}_{r} cos ( ϕ ) . \qquad ( 4 )$$

In our detection scheme, both surface displacement and thermoreflectance exist, such that Aₛ and Δϕ are both modulated by the pump beam at op. Thus, Aₛ and Δϕ can be written as

$${A}_{s} = {{A}_{s , r} ( {C}_{TR} Δ T + 1 )}^{1 / 2} , \qquad ( 5 )$$

$$Δϕ = 2 π ( \frac{2}{λ} ) Δ z + {ϕ}_{DC} ,$$

Where A_{s,r} is the reflected signal field amplitude, C_{TR} is the coefficient of thermoreflectance, λ is the light wavelength, ϕ_{DC} is the phase set point for interferometry detection, and ΔT and Δz are the temperature and surface displacement variations defined as

$$Δ T = {T}_{A} cos ( {ω}_{P} t + Δ {ϕ}_{P} ) , \qquad ( 6 )$$

$$Δ z = {z}_{A} cos ( {ω}_{P} t + Δ {ϕ}_{P} ) ,$$

Where T_{A} and z_{A} are the temperature and surface deformation amplitudes, respectively, and Δϕ_{P} is the phase separation between T_{A} and z_{A} and the incident modulated pump beam. Combining Eqs. 4 and 5 yields

$$S = {\frac{1}{2} [ {{A}_{s , r} ( {C}_{TR} Δ T + 1 )}^{1 / 2} ]}^{2} + \frac{1}{2} {A}_{r}^{2} + {{A}_{s , r} ( {C}_{TR} Δ T + 1 )}^{1 / 2} {A}_{r} cos ( 2 π ( \frac{2}{λ} ) Δ z + {ϕ}_{D C} ) . \qquad ( 7 )$$

Eq. 7 can be reduced to given interferometric detection at ϕ_{DC}=π/2

$$S = \frac{1}{2} {A}_{s , r}^{2} ( {C}_{TR} Δ T + 1 ) + \frac{1}{2} {A}_{r}^{2} + {{A}_{s , r} ( {C}_{TR} Δ T + 1 )}^{1 / 2} {A}_{r} sin ( 2 π ( \frac{2}{λ} ) Δ z ) . \qquad ( 8 )$$

The last term in Eq. 8 takes the following form and can be expanded via Taylor series expansion to a first order approximation applicable to the small amplitude regime as

$${{C}_{1} ( {X}_{1} + 1 )}^{1 / 2} sin ( {X}_{2} ) = {C}_{1} [ 1 + \frac{{X}_{1}}{2} ] \times [ {X}_{2} ] = {C}_{1} ( {X}_{2} + \frac{1}{2} {X}_{1} {X}_{2} ) \qquad ( 9 )$$

Incorporating Eq. 9 into Eq. 8 gives

$$S = \frac{1}{2} {A}_{s , r}^{2} ( {C}_{TR} Δ T + 1 ) + \frac{1}{2} {A}_{r}^{2} + \frac{2 π {A}_{s , r} {A}_{r}}{λ} [ 2 Δ z + {C}_{TR} Δ T Δz ] . \qquad ( 10 )$$

Considering Eq. 6, Eq. 10 can be broken into its various contributions

$$S = \{ \begin{matrix}\frac{1}{2} {A}_{s , r}^{2} + \frac{1}{2} {A}_{r}^{2} \to ( 0 th order ) \\ \frac{1}{2} {A}_{s , r}^{2} {C}_{TR} Δ T + \frac{4 π {A}_{s , r} {A}_{r}}{λ} Δ z \to ( 1 st order ) \\ \frac{4 π {A}_{s , r} {A}_{r}}{λ} {C}_{TR} Δ T Δ z \to ( 2 nd order )\end{matrix} \qquad ( 11 )$$

Let's first consider the 2^{nd} order term and Eq. 6. Here

$$Δ T Δ z = {T}_{A} {z}_{A} {cos}^{2} ( {ω}_{P} t + Δ {ϕ}_{P} ) = \frac{{T}_{A} {z}_{A}}{2} [ cos ( 2 {ω}_{P} t + 2 Δ {ϕ}_{P} ) + 1 ] \qquad ( 12 )$$

As seen in Eq. 12, the 2^{nd} order term contributes a DC term as well as a 2a, term. We can now write out fully Eq. 11

$$( 13 )$$

$$S = \{ \begin{matrix}\frac{1}{2} {A}_{s , r}^{2} + \frac{1}{2} {A}_{r}^{2} + {A}_{s , r} {A}_{r} \frac{π {C}_{TR}}{λ} {T}_{A} {z}_{A} \to ( 0 th order ) \\ \frac{1}{2} {A}_{s , r}^{2} {C}_{TR} {T}_{A} cos ( {ω}_{P} t + Δ {ϕ}_{P} ) + {A}_{s , r} {A}_{r} \frac{4 π}{λ} {z}_{A} cos ( {ω}_{P} t + Δ {ϕ}_{P} ) \to ( 1 st order ) \\ {A}_{s , r} {A}_{r} \frac{π {C}_{TR}}{λ} cos ( 2 {ω}_{P} t + 2 Δ {ϕ}_{P} ) \to ( 2 nd order )\end{matrix}$$

Thus, we can explicitly write the signal detected via lock-in at harmonics of ω_{P} as

$$S ( 0 {ω}_{P} ) = \frac{1}{2} {A}_{s , r}^{2} + \frac{1}{2} {A}_{r}^{2} + {A}_{s , r} {A}_{r} \frac{π {C}_{TR}}{λ} {T}_{A} {z}_{A} \qquad ( 14 )$$

$$S ( 1 {ω}_{P} ) = \frac{1}{2} {A}_{s}^{2} {C}_{TR} {T}_{A} cos ( {ω}_{P} t + Δ {ϕ}_{P} ) + {A}_{s , r} {A}_{r} \frac{4 π}{λ} {z}_{A} cos ( {ω}_{P} t + Δ {ϕ}_{P} )$$

$$S ( 2 {ω}_{P} ) = {A}_{s , r} {A}_{r} \frac{π {C}_{TR}}{λ} cos ( 2 {ω}_{P} t + 2 Δ {ϕ}_{P} )$$

One interesting observation that comes from Eq. 14, is that the 1^{st} harmonic signal is essentially a sum of the thermoreflectance (TR) and surface displacement (SD) components. Thus, these two components can be easily isolated by measuring S(1ω_{P}) and S(1a)|_{A}_{ᵣ}₌₀. For example:

$$TR = S ( 1 {ω}_{P} ) {\vert}_{{A}_{r} = 0} = \frac{1}{2} {A}_{s}^{2} {C}_{TR} {T}_{A} cos ( {ω}_{P} t + Δ {ϕ}_{P} ) \qquad ( 15 )$$

$$SD = S ( 1 {ω}_{P} ) - S ( 1 {ω}_{P} ) {\vert}_{{A}_{r} = 0} = {A}_{s , r} {A}_{r} \frac{4 π}{λ} {z}_{A} cos ( {ω}_{P} t + Δ {ϕ}_{P} )$$

It should be noted the unknowns in this measurement are: T_{A}, z_{A}, and Δϕ_{P}

The illustration of testing environment 100 in FIG. 1 is not meant to imply physical or architectural limitations to the manner in which an illustrative embodiment may be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

For example, in some illustrative examples, there is a thin (˜120 nm) gold layer fabricated on the sample surface to absorb the incident laser light from heating laser 104. In some illustrative examples, the gold layer is optional depending upon operation of the system and the data analysis following operation of the system. As another example, although sample 102 is depicted as possibly heterogeneously integrated microsystem 154, sample 102 can be any desirable type of device, component, or material.

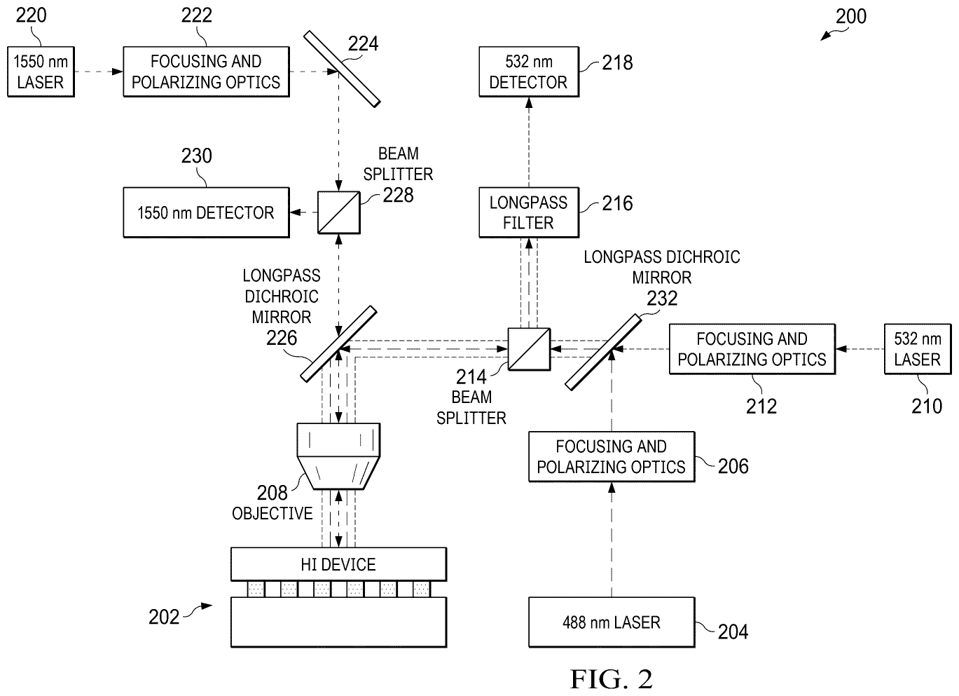

Turning now to FIG. 2, an illustration of a basic layout of a thermomechanical heating response testing system is depicted in accordance with an illustrative embodiment. In some illustrative examples, thermomechanical heating response testing system 200 is a physical implementation of thermomechanical heating response testing system 101 of FIG. 1.

Heterogeneously integrated (HI) device 202 is a physical implementation of sample 102 of FIG. 1. Thermomechanical heating response testing system 200 comprises heating laser 204, thermal probe laser 210, and mechanical probe laser 220. Dichroic mirror 226 is configured to combine beams from the plurality of lasers, heating laser 204, thermal probe laser 210, and mechanical probe laser 220. In this illustrative example, dichroic mirror 226 comprises a longpass dichroic mirror. Objective 208 immediately follows dichroic mirror 226. Objective 208 is configured to focus the beams of the plurality of lasers in a coaxial configuration on the sample, heterogeneously integrated (HI) device 202.

Although heating laser 204 is depicted as having a 488 nm wavelength, heating laser 204 can comprise any desirable wavelength configured to generate heat in the sample, heterogeneously integrated (HI) device 202. Heating laser 204 is sent through focusing and polarizing optics 206 prior to dichroic mirror 232.

Although thermal probe laser 210 is depicted as having a 532 nm wavelength, thermal probe laser 210 can comprise any desirable wavelength configured to reflect off the sample, heterogeneously integrated (HI) device 202. Thermal probe laser 210 is sent through focusing and polarizing optics 212 prior to dichroic mirror 232. Dichroic mirror 232 directs beams of heating laser 204 and thermal probe laser 210 together towards dichroic mirror 226.

Although, mechanical probe laser 220 is depicted as having 1550 nm wavelength, mechanical probe laser 220 can comprise any desirable wavelength configured to be used for interferometry. Mechanical probe laser 220 is sent through focusing and polarizing optics 222 dichroic 224 and beam splitter 228 prior to dichroic mirror 226.

Dichroic mirror 226 combines beams from heating laser 204, thermal probe laser 210, and mechanical probe laser 220. Objective 208 immediately following dichroic mirror 226 is configured to focus the beams of the plurality of lasers in a coaxial configuration on heterogeneously integrated (HI) device 202.

Beam splitter 228 and beam splitter 214 are present to direct reflected signals towards respective detectors. Reflected signals of mechanical probe laser 220 pass through dichroic mirror 226 to beam splitter 228. Beam splitter 228 directs reflected signals of mechanical probe laser 220 to mechanical probe detector 230. Reflected signals of thermal probe laser 210 are directed by dichroic mirror 226 to beam splitter 214. Beam splitter 214 directs reflected signals of thermal probe laser 210 through longpass filter 216 to thermal probe detector 218.

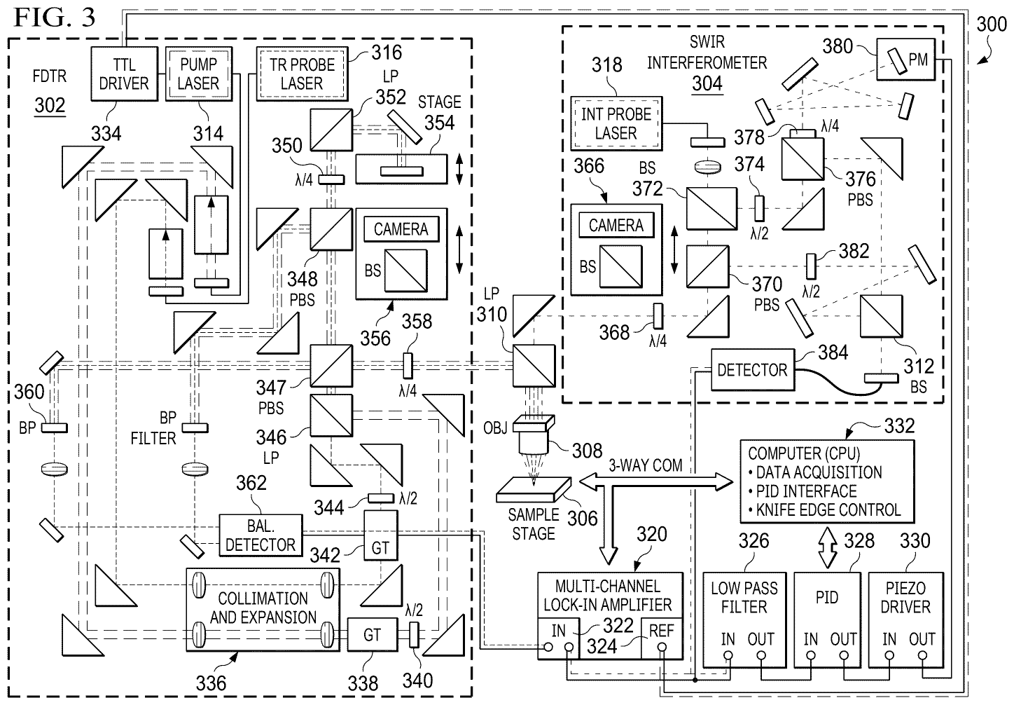

Turning now to FIG. 3, an illustration of a detailed layout of a thermomechanical heating response testing system is depicted in accordance with an illustrative embodiment. Thermomechanical heating response testing system 300 is a physical depiction of physical implementation of thermomechanical heating response testing system 101 of FIG. 1. In some illustrative examples, thermomechanical heating response testing system 300 is a more detailed optical diagram of thermomechanical heating response testing system 200.

Thermomechanical heating response testing system 300 is a more detailed optical diagram of a T-MeHR system, noting the locations of longpass dichroic mirrors (labeled as LP in the figure), polarizing beam splitters (PBS), beam splitters (BS), Glan-Thompson polarizers (GT), band pass filters (BP), half waveplates (λ/2), quarter wave plates (λ/4), isolators (denoted as an arrow) and balance detectors (Bal. Det.). Thermomechanical heating response testing system 300 also comprises other features, such as collimation optics (lenses to focus the light on the appropriate spot), cameras, the objective and a movable piezo mirror.

Thermomechanical heating response testing system 300 comprises frequency domain thermoreflectance (FDTR) 302 components and interferometer 304. In some illustrative examples, interferometer 304 can take the form of a SWIR interferometer.

Beams from heating laser 314, labeled as pump laser, and thermal probe laser 316, labeled as thermoreflectance (TR) probe laser, of frequency domain thermoreflectance (FDTR) 302 components are directed to longpass dichroic mirror 346. Beam from mechanical probe laser 318 are directed to non-polarizing beam splitter BS 312.

Beams from heating laser 314 and thermal probe laser 316 are put through collimation and expansion 336 to condition beam sizes. The heating beam light then goes through Glan-Thompson Polarizer 338 to isolate one polarization of light, then λ/2 waveplate 340, which can rotate the isolated polarization about the propagation direction. The thermal probe beam light also goes through Glan-Thompson Polarizer 342 to isolate one polarization of light, then λ/2 waveplate 344, which can rotate the isolated polarization about the propagation direction. This creates light of polarization for both the heating and thermal probe beams that can be controlled and modified to optimize the measurement based on the polarization changes made by the rest of the optical system. Beams from heating laser 314 and thermal probe laser 316 are then combined with the longpass dichroic mirror 346 and put through a polarizing beam splitter 347. The heating beam polarization is selected by λ/2 waveplate 340 to maximize heating laser beam intensity on the sample, while the thermal probe beam polarization is selected by λ/2 waveplate 344 provide equal intensity in the sample and reference paths. In the sample path the light goes through a λ/4 waveplate 358, so linearly polarized light is converted to circularly polarized. After reflection with the sample, the circularly polarized light changes handedness, causing this light to preferably transmitted toward the detector. The transmitted light is passed through a band pass filter 360 to remove the pump wavelength, then focused on a detector, balance detector 362. In the reference path the light goes through a second polarizing beam splitter 348 and also goes through a λ/4 waveplate 350, so linearly polarized light is converted to circularly polarized. After reflection with a movable mirror on translation stage 354, the circularly polarized light changes handedness, causing this light to preferably reflect toward the detector through polarizing beam splitter 348. The transmitted light is passed through a band pass filter 360 to remove the pump wavelength, then focused on a detector, balance detector 362. The two inputs of balance detector 362 are subtracted, and this signal is measured by multichannel lock-in amplifier 320. Longpass dichroic mirrors 310 and 352 are identical such that polarization impacts are compensated in each path.

Balance detector 362 subtracts signals from the “signal path” and the “reference path”. The signal path is a beam that is reflected off of the sample surface of sample 306 and makes its way to balance detector 362. In this illustrative example, the signal path is defined by the path that goes through polarizing beam splitter (PBS) 348, quarter (λ/4) waveplate 350, dichroic mirror 352, stage 354, dichroic mirror 352, quarter (λ/4) waveplate 350, polarizing beam splitter (PBS) 348, bandpass filter (BP), and balance detector 362. The reference path is defined by the path that goes through polarizing beam splitter (PBS) 348, longpass dichroic filter (LP) 352, stage 354, longpass dichroic mirror (LP) 352, quarter (λ/4) waveplate 350, polarizing beam splitter (PBS) 348, and balance detector 362.

The signal path and reference path the beam travels the same length. The difference between the signal path and reference path is reflection off sample 306 instead of stage 354 with a mirror. When these signals are subtracted at balance detector 362, the effect of the sample reflection remains.

In this case, the system of polarizing beam splitter 347 reflects or transmits light based on its polarization (s or p), which quarter (λ/4) waveplate 358 switches. Because the beam goes through the waveplate switches twice, the polarization of the light will switch between transmission and reflection at the polarizing beam splitter 347.

Beams from mechanical probe laser 318, labeled as int probe laser, go through a similar path to create the signal and reference beams which are combined before detector 384. The interference between these two beams is measured by detector 384, with the option of doing balance detection by subtracting the interference from the original signal beam. As depicted, balance detection is not used for the interferometric signal.

As depicted, mechanical probe laser 318 goes through beam splitter 372, polarizing beam splitter (PBS) 370, and quarter (λ/4) waveplate 368 prior to dichroic mirror 310 and objective 308. Camera system 366 is used to verify positioning of the beam of mechanical probe laser 318. A portion of mechanical probe laser 318 is directed through half (λ/2) waveplate 374, polarizing beam splitter (PBS) 376, quarter (λ/4) waveplate 378, and piezo mirror (PM) 380 to form a reference signal. The sample signal returns from sample 306 through objective 308, dichroic mirror 310, quarter (λ/4) waveplate 368, polarizing beam splitter (PBS) 370, half (λ/2) waveplate 382, mechanical probe detector 384, and beam splitter 312 before reaching detector 384.

The multichannel lock-in amplifier 320 is used to drive the heating laser 314 through TTL driver 334 as well as collected signals from interferometer detector 384 and balanced detector 362. The multichannel lock-in amplifier 320 is in communication with computer 332. Computer 332 is used for data acquisition, interferometer feedback control interface, and knife edge beam profiling.

The multichannel lock-in amplifier 320 input 322 receives data from mechanical probe detector 384 and balance detector 362. The multichannel lock-in amplifier reference 324 supplies the heating laser 314 drive signal to Transistor Transistor Logic Driver (TTL) 334.

The interferometer detector signal is split before multichannel lock-in amplifier 320, where the voltage is received by a low pass filter 326, which isolates low frequency drift in the interferometer that is used as input to feedback controller (PID) 328. The computer 332 controls feedback controller (PID) 328 setpoint and feedback gains. The output of feedback controller (PID) 328 is amplified by piezo driver 330, which drives piezo mirror (PM) 380.

The beams from heating laser 314, thermal probe laser 316, and mechanical probe laser 318 are combined immediately before objective 308 using dichroic mirror 310 to transmit the light from mechanical probe laser 318 and reflect heating laser 314 and thermal probe laser 316. In some illustrative examples, dichroic mirror 310 is a longpass (LP) dichroic mirror. With correct alignment into the objective, this allows the three beams from heating laser 314, thermal probe laser 316, and mechanical probe laser 318 to be brought into coaxial configuration such that the center of the three beams is on the same axis and focused to the surface of sample 306. Keeping mechanical probe laser 318 beams separate for as much of the beam as possible reduces alignment complexity by not requiring broadband optics at each point in the beam path. Earlier in the beam path of heating laser 314 and thermal probe laser 316, the beams are combined using another longpass dichroic mirror 346.

In this illustrative example, two separate camera systems, visible camera system 356 and infrared camera system 366, are provided in thermomechanical heating response testing system 300. Utilizing visible camera system 356 and infrared camera system 366 allows for the visibility of the laser placement. Utilizing multiple cameras allows for directing the lasers to sample 306. In some illustrative examples, the setup is on a floating table with two layers of vibration isolation.

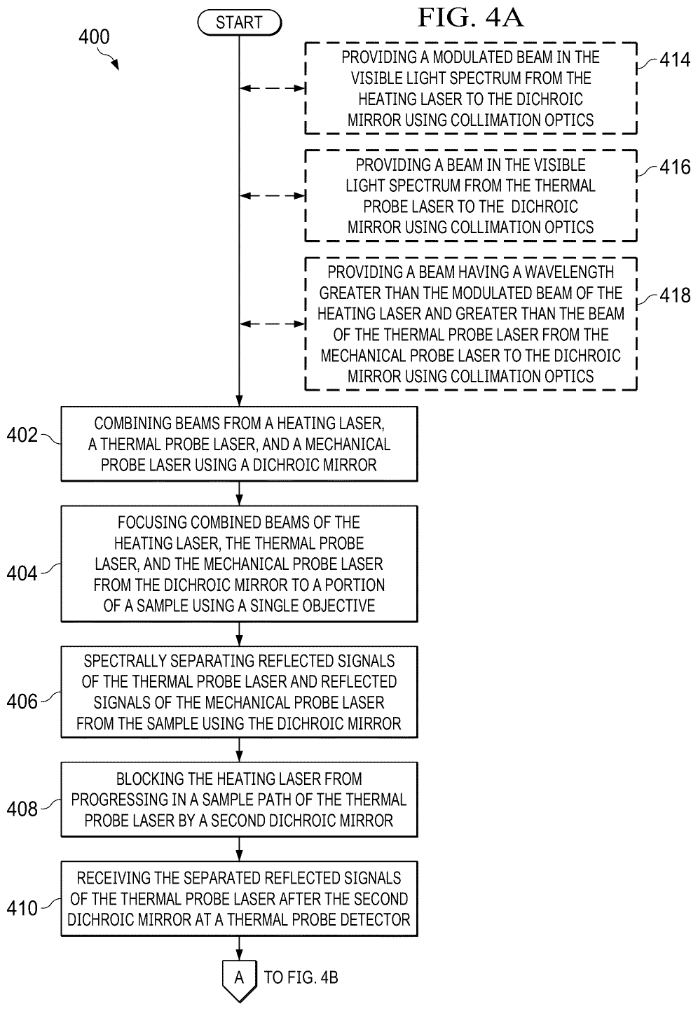

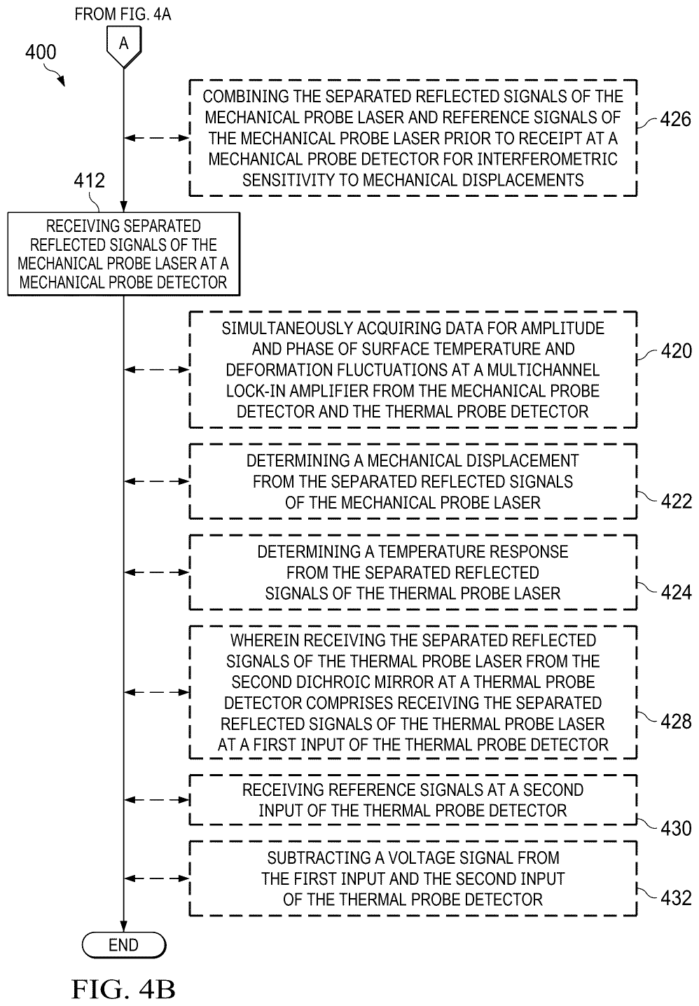

Turning now to FIGS. 4A and 4B, a flowchart for performing a thermomechanical test on a sample is depicted in accordance with an illustrative embodiment. Method 400 can be performed using thermomechanical heating response testing system 101 of FIG. 1. Method 400 can be performed using thermomechanical heating response testing system 201 of FIG. 2. Method 400 can be performed using thermomechanical heating response testing system 301 of FIG. 3.

Method 400 combines beams from a heating laser, a thermal probe laser, and a mechanical probe laser using a dichroic mirror (operation 402). Method 400 focuses combined beams of the heating laser, the thermal probe laser, and the mechanical probe laser from the dichroic mirror to a portion of a sample using a single objective (operation 404).

Method 400 spectrally separates reflected signals of the thermal probe laser and reflected signals of the mechanical probe laser from the sample using the dichroic mirror (operation 406). In some illustrative examples, method 400 separates reflected signals of the thermal probe laser and reflected signals of the mechanical probe laser from the sample from incident beam using a polarizing beam splitter. Method 400 blocks the heating laser from progressing in a sample path of the thermal probe laser by a second dichroic mirror (operation 408). Method 400 receives the separated reflected signals of the thermal probe laser after the second dichroic mirror at a thermal probe detector (operation 410). Method 400 receives separated reflected signals of the mechanical probe laser at a mechanical probe detector (operation 412). Afterwards, method 400 terminates.

In some illustrative examples, method 400 further comprises providing a modulated beam in the visible light spectrum from the heating laser to the dichroic mirror using collimation optics (operation 414). In some illustrative examples, method 400 further comprises providing a beam in the visible light spectrum from the thermal probe laser to the dichroic mirror using collimation optics (operation 416). In some illustrative examples, method 400 further comprises providing a beam having a wavelength greater than the modulated beam of the heating laser and greater than the beam of the thermal probe laser from the mechanical probe laser to the dichroic mirror using collimation optics (operation 418).

In some illustrative examples, method 400 further comprises simultaneously acquiring data for amplitude and phase of surface temperature and deformation fluctuations at a multichannel lock-in amplifier from the mechanical probe detector and the thermal probe detector (operation 420). In some illustrative examples, method 400 further comprises determining a mechanical displacement from the separated reflected signals of the mechanical probe laser (operation 422). In some illustrative examples, method 400 further comprises determining a temperature response from the separated reflected signals of the thermal probe laser (operation 424).

Method 400 further comprises combining the separated reflected signals of the mechanical probe laser and reference signals of the mechanical probe laser prior to receipt at a mechanical probe detector for interferometric sensitivity to mechanical displacements (operation 426).

In some illustrative examples, receiving the separated reflected signals of the thermal probe laser from the second dichroic mirror at a thermal probe detector comprises receiving the separated reflected signals of the thermal probe laser at a first input of the thermal probe detector (operation 428). In some illustrative examples, method 400 further comprises receiving reference signals at a second input of the thermal probe detector (operation 430).

In some illustrative examples, method 400 further comprises subtracting a voltage signal from the first input and the second input of the thermal probe detector (operation 432).

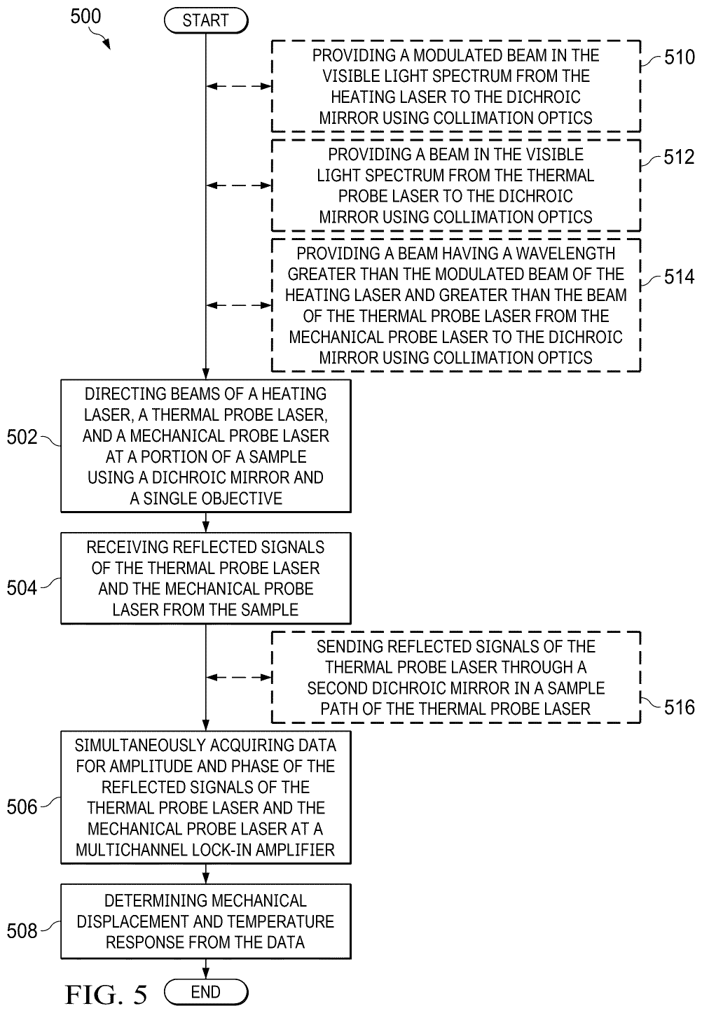

Turning now to FIG. 5, a flowchart for performing a thermomechanical test on a sample is depicted in accordance with an illustrative embodiment. Method 500 can be performed using thermomechanical heating response testing system 101 of FIG. 1. Method 500 can be performed using thermomechanical heating response testing system 201 of FIG. 2. Method 500 can be performed using thermomechanical heating response testing system 301 of FIG. 3.

Method 500 directs beams of a heating laser, a thermal probe laser, and a mechanical probe laser at a portion of a sample using a dichroic mirror and a single objective (operation 502). Method 500 receives reflected signals of the thermal probe laser and the mechanical probe laser from the sample (operation 504). Method 500 simultaneously acquires data for amplitude and phase of the reflected signals of the thermal probe laser and the mechanical probe laser at a multichannel lock-in amplifier (operation 506). Method 500 determines mechanical displacement and temperature response from the data (operation 508). Afterwards, method 500 terminates.

In some illustrative examples, method 500 further comprises providing a modulated beam in the visible light spectrum from the heating laser to the dichroic mirror using collimation optics (operation 510).

In some illustrative examples, method 500 further comprises providing a beam in the visible light spectrum from the thermal probe laser to the dichroic mirror using collimation optics (operation 512).

In some illustrative examples, method 500 further comprises providing a beam having a wavelength greater than the modulated beam of the heating laser and greater than the beam of the thermal probe laser from the mechanical probe laser to the dichroic mirror using collimation optics (operation 514).

In some illustrative examples, method 500 further comprises sending reflected signals of the thermal probe laser through a second dichroic mirror in a sample path of the thermal probe laser (operation 516).

As used herein, the phrase “a number” means one or more. The phrase “at least one of”, when used with a list of items, means different combinations of one or more of the listed items may be used, and only one of each item in the list may be needed. In other words, “at least one of” means any combination of items and number of items may be used from the list, but not all of the items in the list are required. The item may be a particular object, a thing, or a category.

For example, without limitation, “at least one of item A, item B, or item C” may include item A, item A and item B, or item C. This example also may include item A, item B, and item C, or item B and item C. Of course, any combinations of these items may be present. In some illustrative examples, “at least one of” may be, for example, without limitation, two of item A; one of item B; and ten of item C; four of item B and seven of item C; or other suitable combinations.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step. For example, one or more of the blocks may be implemented as program code.

In some alternative implementations of an illustrative embodiment, the function or functions noted in the blocks may occur out of the order noted in the figures. For example, in some cases, two blocks shown in succession may be performed substantially concurrently, or the blocks may sometimes be performed in the reverse order, depending upon the functionality involved. Also, other blocks may be added in addition to the illustrated blocks in a flowchart or block diagram. Some blocks may be optional. For example, operation 414 through operation 432 may be optional. As another example, operation 510 through operation 516 may be optional.

The illustrative examples provide focusing and polarizing optics to direct three beams through the center of a microscope objective, which focuses the beams on the sample of interest. A heating laser is present to heat the sample. The heating laser is modulated so the heating at the sample surface is periodic. In some illustrative examples, there is a thin (˜120 nm) gold layer deposited on the sample surface to absorb the incident heating laser light. A thermal probe laser is present to measure the temperature change of the sample and a mechanical probe detector is present for the measurement of mechanical displacement using interferometry.

The illustrative examples can be used to investigate the thermal and mechanical properties of bonded semiconductors versus unbonded semiconductors for the purpose of failure analysis in heterogeneously integrated microelectronic devices. In some silicon pieces, mechanical displacement signals between the bonded and unbonded regions are much larger than the difference in the thermal signals. The illustrative examples can provide better detection of damage or debonding in samples using the mechanical displacement signals than by using existing thermal methods. In some illustrative examples, the combination of thermal measurements and mechanical measurements can be analyzed by inverse modeling and machine learning to extract more confident predictions of sample damage or debonding.

Simultaneous thermal and mechanical data are gathered during testing. Testing simultaneously acquires amplitude and phase of surface temperature and deformation fluctuations.

Surface displacement data shows similar trends with amplitude trending away from zero with decreasing frequency and phase trending towards zero as heating frequency decreases. The excitation source is the same for the temperature and displacement data. For example, the thermal conductivity and CTE of SiO2 is much less than silicon. While the temperature data shows a large difference between SiO2 and silicon due SiO2's lower thermal conductivity, the displacement data is more similar, since SiO2 expands less (i.e., lower CTE). The net result is the two displacement datasets are more similar than the two thermal datasets. Multiphysics detection of the T-MeHR system offers increased detection ability as compared to single physics (i.e. thermal alone) measurements.

The T-MeHR system can be used to collect thermal and mechanical datasets to simultaneously determine material characteristics. The T-MeHR system can be used to collect thermal and mechanical datasets to simultaneously determine thermal conductivity and mechanical properties, such as coefficient of thermal expansion. This combined approach is novel and could substantially streamline characterization of materials.

The illustrative examples can allow for integration of HI electronic components into commercial or government systems due to new characterization options and improved inspection provided by the illustrative examples. The illustrative examples can offer chip-scale characterization of HI assemblies and can be used to evaluate as-built parts for bond quality and perform aging studies to examine how thermomechanical failure occurs and evolves. Use of shorter wavelengths in the thermal and/or mechanical components of T-MeHR (e.g., UV) could be used for a fully nondestructive technique that lessens the use of a metal transducer layer to acquire signals. The increased ability to perform characterization and failure analysis is expected to reduce time to iterate and test designs, with long term potential to qualify HI systems for use.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiment. The terminology used herein was chosen to best explain the principles of the embodiment, the practical application or technical improvement over technologies found in the marketplace, or to enable others of ordinary skill in the art to understand the embodiments disclosed here.

What is claimed is:

1. A thermomechanical heating response testing system comprising:
a dichroic mirror configured to combine beams from a plurality of lasers;
an objective immediately following the dichroic mirror, the objective configured to focus the beams of the plurality of lasers in a coaxial configuration on a sample;
the plurality of lasers, the plurality of lasers comprising:
a heating laser having a first wavelength;
a thermal probe laser having a second wavelength; and
a mechanical probe laser having a third wavelength; and
a multichannel lock-in amplifier configured to receive input from a thermal probe detector configured to receive a thermal probe sample beam of the thermal probe laser reflected from a sample and a mechanical probe detector configured to receive a mechanical probe sample beam of the mechanical probe laser reflected from the sample.

2. The thermomechanical heating response testing system of claim 1, wherein the first wavelength and the second wavelength are in the visible light spectrum.

3. The thermomechanical heating response testing system of claim 1, wherein the third wavelength is in the infrared spectrum.

4. The thermomechanical heating response testing system of claim 1, wherein the first wavelength is configured to generate heat in the sample.

5. The thermomechanical heating response testing system of claim 1, wherein the first wavelength and the second wavelength are shorter wavelengths than the third wavelength.

6. The thermomechanical heating response testing system of claim 1 further comprising:
a second dichroic mirror in a sample path of the thermal probe laser.

7. The thermomechanical heating response testing system of claim 1 further comprising:
a band pass filter configured to remove the first wavelength from a reference sample.

8. The thermomechanical heating response testing system of claim 1, wherein displacement sensitivity from the mechanical probe laser is obtained via interferometry, and wherein the mechanical probe beam from the sample is combined with the mechanical probe reference before the mechanical probe detector.

9. A method of performing a thermomechanical test on a sample comprising:
combining beams from a heating laser, a thermal probe laser, and a mechanical probe laser using a dichroic mirror;
focusing combined beams of the heating laser, the thermal probe laser, and the mechanical probe laser from the dichroic mirror to a portion of a sample using a single objective;
spectrally separating reflected signals of the thermal probe laser and reflected signals of the mechanical probe laser from the sample using the dichroic mirror;
blocking the heating laser from progressing in a sample path of the thermal probe laser by a second dichroic mirror;
receiving the separated reflected signals of the thermal probe laser after the second dichroic mirror at a thermal probe detector; and
receiving separated reflected signals of the mechanical probe laser at a mechanical probe detector.

10. The method of claim 9 further comprising:
providing a modulated beam in the visible light spectrum from the heating laser to the dichroic mirror using collimation optics.

11. The method of claim 10 further comprising:
providing a beam in the visible light spectrum from the thermal probe laser to the dichroic mirror using collimation optics; and
providing a beam having a wavelength greater than the modulated beam of the heating laser and greater than the beam of the thermal probe laser from the mechanical probe laser to the dichroic mirror using collimation optics.

12. The method of claim 9 further comprising:
simultaneously acquiring data for amplitude and phase of surface temperature and deformation fluctuations at a multichannel lock-in amplifier from the mechanical probe detector and the thermal probe detector.

13. The method of claim 9 further comprising:
determining a mechanical displacement from the separated reflected signals of the mechanical probe laser.

14. The method of claim 9 further comprising:
determining a temperature response from the separated reflected signals of the thermal probe laser.

15. The method of claim 9 further comprising:
combining the separated reflected signals of the mechanical probe laser and reference signals of the mechanical probe laser prior to receipt at a mechanical probe detector for interferometric sensitivity to mechanical displacements.

16. The method of claim 9, wherein receiving the separated reflected signals of the thermal probe laser from the second dichroic mirror at a thermal probe detector comprises receiving the separated reflected signals of the thermal probe laser at a first input of the thermal probe detector, and wherein the method further comprises:
receiving reference signals at a second input of the thermal probe detector.

17. The method of claim 16 further comprising:
subtracting a voltage signal from the first input and the second input of the thermal probe detector.

18. A method of performing a thermomechanical test on a sample comprising:
directing beams of a heating laser, a thermal probe laser, and a mechanical probe laser at a portion of a sample using a dichroic mirror and a single objective;
receiving reflected signals of the thermal probe laser and the mechanical probe laser from the sample; and
simultaneously acquiring data for amplitude and phase of the reflected signals of the thermal probe laser and the mechanical probe laser at a multichannel lock-in amplifier; and
determining mechanical displacement and temperature response from the data.

19. The method of claim 18 further comprising:
providing a modulated beam in the visible light spectrum from the heating laser to the dichroic mirror using collimation optics.

20. The method of claim 19 further comprising:
providing a beam in the visible light spectrum from the thermal probe laser to the dichroic mirror using collimation optics; and
providing a beam having a wavelength greater than the modulated beam of the heating laser and greater than the beam of the thermal probe laser from the mechanical probe laser to the dichroic mirror using collimation optics.

21. The method of claim 18 further comprising:
sending reflected signals of the thermal probe laser through a second dichroic mirror in a sample path of the thermal probe laser.
